(19) United States
(12) Patent Application Publication
(10) Pub. No.: US 2012/0180755 A1
(43) Pub. Date: Jul. 19, 2012

(54) Injector

(76) Inventors: Uwe Jung, Worth a.d. Donau (DE); Gabriel Marzahn, Regensburg (DE); Wolfgang Reisinger, Regenstauf (DE)

(21) Appl. No.: 13/350,185

(22) Filed: Jan. 13, 2012

(30) Foreign Application Priority Data
Jan. 13, 2011 (DE) 10 2011 008 467.3

(51) Int. Cl. F02M 55/00; F02M 51/00

(52) U.S. Cl. 123/294; 239/585.1

(57) ABSTRACT

An injector includes a control valve for opening a connection between a control chamber for controlling a nozzle needle position and a prechamber of a fluid return line, wherein a pressure compensation device is arranged in the prechamber for compensating a change in a prechamber pressure.

### CROSS-REFERENCE TO RELATED APPLICATIONS

This application claims priority to DE Patent Application No. 2011 008 467.3 filed Jan. 13, 2011. The contents of which is incorporated herein by reference in its entirety.

### TECHNICAL FIELD

The invention relates to an injector, e.g., a fuel injector for a vehicle.

### BACKGROUND

Known injectors for injecting a fuel into a combustion chamber of an internal combustion engine generally comprise a control valve for opening a connection between a control chamber for controlling a nozzle needle position and a prechamber of a fluid return line.

The extraction of fuel through injection and switching leakage triggers pressure waves in the high-pressure and low-pressure regions of the injector.

Since a control valve actuator of the injector generally projects with a diaphragm of relatively large area into the low-pressure region, which diaphragm seals off the actuator from the fuel, and a pressure of approximately 2.3 bar typically prevails in the low-pressure region, an actuator movement and therefore the injected quantity of fuel is sensitive to disturbance by different pressure conditions in the low-pressure region, because partially considerable additional forces act on the actuator via the diaphragm surface.

Specifically, in the first injection per engine cycle, during the movement of the actuator, which in the case of a piezo element as an actuator is an expansion, the liquid fuel situated in front of the diaphragm surface must be displaced. In the case of the piezo element, this displacement must take place within a charging time of the piezo element. A charging time of a piezo element is in particular 200 μs. Here, the inertia of the incompressible liquid column causes a pressure peak of for example 40 bar, and therefore a high counteracting force. In the case of discharging, during the contraction of the diaphragm, a vacuum is generated in front of the vacuum because the liquid column continues to move away from the diaphragm. Only after a certain time duration does the liquid, that is to say the fuel, return into the actuator diaphragm prechamber, either driven by the leakage excess pressure or owing to pressure wave reflections in the leakage chamber.

Therefore, undefined conditions, for example pressure conditions, prevail in front of the actuator diaphragm during injections following the first injection: there is situated here either a vacuum, or air outgassed from the fuel, or liquid.

The different counteracting forces furthermore cause different valve movements and therefore different injection quantities.

### SUMMARY

According to various embodiments, an injector which overcomes the known disadvantages and which permits a defined injection quantity of fluid can be provided.

According to an embodiment, an injector includes a control valve for opening a connection between a control chamber for controlling a nozzle needle position and a prechamber of a fluid return line, and a pressure compensation means arranged in the prechamber for compensating a change in a prechamber pressure.

According to a further embodiment, the pressure compensation means may have at least one body which is sealed off with respect to the prechamber and in which there is arranged a compressible medium. According to further embodiments, the compressible medium may comprise a gas or a foamed material. According to a further embodiment, an actuator can be provided for actuating the control valve and wherein the body is formed as a double-walled diaphragm which seals off the actuator with respect to the prechamber. According to a further embodiment, the body can be in the shape of a ring, ball or polygon.

### BRIEF DESCRIPTION OF THE DRAWINGS

Example embodiments will be explained in more detail below with reference to figures, in which:

FIG. 1 shows a cross-sectional view of an injector according to certain embodiments,

FIG. 2 shows a detail view of a prechamber of a conventional injector,

FIG. 3 shows a detail view of a prechamber of the injector from FIG. 1, and

FIG. 4 shows a detail view of a further embodiment of the prechamber of the injector from FIG. 1.

### DETAILED DESCRIPTION

According to certain embodiments, an injector is provided which has a control valve for opening a connection between a control chamber for controlling a nozzle needle position and a prechamber of a fluid return line. A pressure compensation means is arranged in the prechamber for compensating a change in a prechamber pressure. Within the context of this disclosure, a fluid may encompass in particular a gas or a liquid. The fluid may be a fuel, for example diesel or gasoline.

The pressure changes which arise in the prechamber during the injection process are advantageously compensated by means of the pressure compensation means, such that constant pressure conditions prevail in the prechamber. This furthermore has the advantageous result that falsification of the injection quantities can no longer occur in the case of multiple injections or after a relatively long standstill period, when for example gas has accumulated in front of an actuator diaphragm. The injector thus provides a precisely defined quantity of fluid, in particular fuel, for every injection process.

Furthermore, the pressure compensation means advantageously also reduces a counteracting force during an actuator movement. As a result, the actuator can in particular be of smaller and therefore cheaper design. In this respect, less energy need be provided for actuating the actuator. A control unit of the actuator may consequently also be designed to be cheaper and smaller, because it can be designed for lower energy levels and lower power losses.

Furthermore, operating noise of the injector is decreased. The injector is thus made quieter, for the following reason. The injected quantity of fluid, for example fuel, is no longer falsified by low-pressure oscillations and/or low-pressure effects. Consequently, a vacuum is no longer generated in front of the actuator diaphragm, and outgassing no longer occurs. These processes generally produce considerable acoustic emissions, such that the reduction or elimination of these emissions leads to quieter operating noise.

In one embodiment, the pressure compensation means comprises at least one body which is sealed off with respect to the prechamber and in which a compressible medium is arranged. In this way, the pressure compensation means can be adapted in a flexible manner to the prechamber geometry. In a further embodiment, it is also possible for a plurality of such bodies to be provided. The body is advantageously a compressible body. This means in particular that it can be compressed and expanded, as a result of which an internal volume of the body changes. The body may also be of rigid design. In this case, the body then comprises a pressure compensation valve, such that an internal pressure of the body can be balanced with a prechamber pressure.

In a further embodiment, the medium comprises a gas. Gas has the advantage that it is particularly compressible, such that a body of said type can compensate considerable pressure changes. The gas may be air. Air has the advantage that it does not have to be produced in a cumbersome manner, and is not harmful to health.

In another embodiment, the medium comprises a foamed material. A foamed material, despite having high compressibility, also has high dimensional stability, such that a corresponding body also has this property. A closed-pored foamed material may be provided. In particular, a closed-cell, open-cell or mixed-cell foamed material may be provided. The foamed material may for example also be formed as an integral foam.

In a further embodiment, a plurality of bodies may be provided, in which different or identical compressible media are arranged.

In another embodiment, an actuator is provided for actuating the control valve, wherein the body is formed as a double-walled diaphragm which seals off the prechamber and in which there is advantageously arranged a compressible medium. The double-walled diaphragm thus advantageously serves to seal off the actuator with respect to the fluid, in particular fuel, and also to provide compensation of the pressure changes arising in the prechamber. The diaphragm may be welded and/or adhesively bonded to an actuator housing. Reliable and permanent fastening of the diaphragm can advantageously be attained in this way. In a further embodiment, the double-walled diaphragm may also be attached to an already existing actuator diaphragm, such that a known injector can advantageously be retroactively upgraded in a particularly simple manner.

In a further embodiment, the actuator is a piezo element. In this case, the actuator may also be referred to as a piezo actuator. A piezo element requires only relatively low voltages for a corresponding actuator movement, and is at the same time adequately stable with respect to temperature and vibration, such that for example demands in the automotive field can be met. In particular, a piezo element can actuate, that is to say open or close, the control valve in less than 100 μs. The piezo element may be formed as a stack using so-called multi-layer technology, in which multiple individual ceramic plates are connected to one another.

In another embodiment, the pressure compensation means may have the double-walled diaphragm and one or more bodies in each case comprising a compressible medium, wherein the respective media may be the same or different.

In a further embodiment, the body has an annular, spherical or polygonal form. If multiple bodies are provided, these may be of the same form or different forms. Space in the prechamber can be utilized in a particularly effective manner through suitable selection of the appropriate form. It is possible in particular for a prechamber geometry to be taken into consideration. If multiple bodies are provided, these may, corresponding to their form, be packaged and arranged in the prechamber in a particularly space-saving manner. The polygonal form may encompass a rectangular form, in particular a square form, an octagonal form or a hexagonal form.

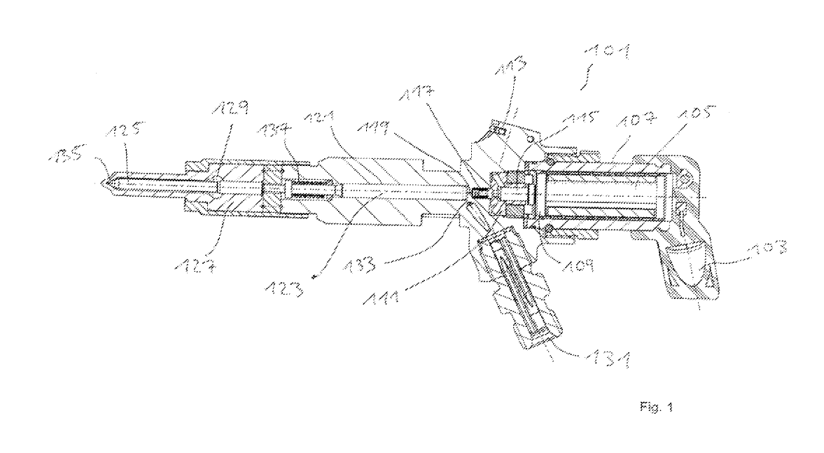

FIG. 1 shows a cross-sectional view of an injector 101 according to some embodiments. The injector 101 comprises an electrical terminal 103 for a voltage supply of a piezo actuator 105 which is arranged in an actuator housing 107. The actuator housing 107 is sealed off in a fluid-tight manner with respect to a prechamber 111 by means of a double-walled diaphragm 109. The prechamber 111 is positioned upstream of and fluidically connected to a fluid return line (not shown), such that the prechamber 111 may also be referred to as a prechamber of the fluid return line. The injector 101 also has a low-pressure port 113 to which the fluid return line is connected. The double-walled diaphragm 109 will be described in greater detail in FIG. 3.

Furthermore, an actuator piston 115 is arranged in the prechamber 111 such that an expansion of the piezo actuator 105 can be transmitted to a control valve 117. The piezo actuator 105 is thus coupled by means of the actuator piston 115 to the control valve 117. The actuator piston 115 may also be referred to as a control valve actuator. The control valve 117 opens and closes a connecting duct 119 between the prechamber 111 and a control chamber 121. The connecting duct 119 is designed preferably as a throttle.

Also arranged in the control chamber 121 is a control piston 123 which can actuate a nozzle needle 125 of an injector nozzle 127. The nozzle needle 125 is arranged in a nozzle high-pressure chamber 129 into which a fuel such as for example diesel or gasoline is conducted. For this purpose, the injector 101 has a fluid port 131 which constitutes a fuel port. In an embodiment which is not shown, the fluid port 131 comprises a filter in order to advantageously filter the fluid to be conducted into the injector 101. The fluid port 131 also has an inlet throttle 133.

The mode of operation of the injector 101 according to certain embodiments will be explained in more detail below.

When the injector 101 is not being actuated, fuel at a high pressure, typically 1000 bar to 2000 bar, is situated both in the control chamber 121 and also in the high-pressure chamber of the nozzle, that is to say the nozzle high-pressure chamber 129. The connecting duct 119 between the control chamber 121 and the fluid return line is closed off by means of the control valve 117. A hydraulic force exerted on the nozzle needle 125 in the control chamber 121 by the fuel high pressure is greater than the hydraulic force acting on a nozzle needle tip 135, because an area of the control piston 123 in the control chamber 121 is larger than a free area under the nozzle needle 125. The injector nozzle 127 of the injector 101 is thus closed.

If the injector 101 is actuated, for example by virtue of an electrical voltage being applied to the piezo actuator 105, the piezo actuator 105 presses on the control valve 117 via the actuator piston 115, such that the connecting duct 119 to the fluid return line opens. This results in a pressure drop in the control chamber 121, and the hydraulic force acting on the nozzle needle tip 135 becomes greater than the force acting on the control piston 123. The nozzle needle 125 moves in the direction of the control chamber 121 and thus opens the injector nozzle 127. Fuel thus passes via injection holes (not shown) of the injector nozzle 127 into a combustion chamber (not shown) of an internal combustion engine (not shown).

When the internal combustion engine is not in operation, the control valve 117 and the injector nozzle 127 are preferably closed by a spring force provided by means of a spring 137.

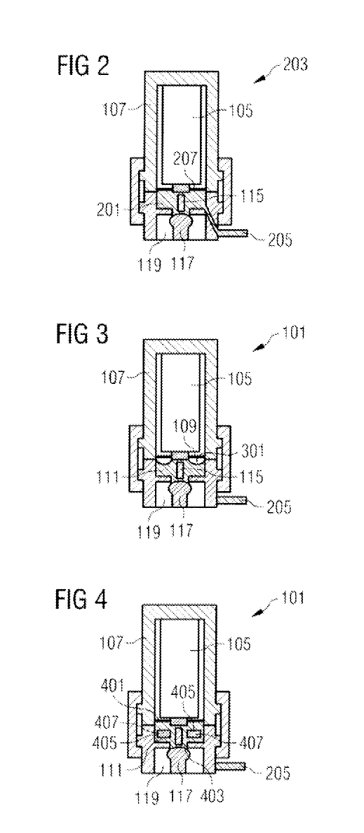

FIG. 2 shows a sectional detail view of a prechamber 201 of a conventional injector 203, wherein the known prechamber 201 is at least partially of similar design to the prechamber 111 of the injector 101 from FIG. 1. The same reference numerals are thus used for the same elements at relevant locations.

FIG. 2 shows the fluid return line which is not shown in FIG. 1, said fluid return line being denoted here by the reference numeral 205. The fuel situated in the prechamber 201 is indicated by hatching for better clarity.

A significant difference between the known prechamber 201 and the prechamber 111 of the injector 101 according to certain embodiments is that the diaphragm which seals off the piezo actuator 105 from the prechamber 201 in a fluid-tight manner is designed not as a double-walled diaphragm but rather as a single-walled diaphragm 207. A change in pressure arising owing to the moving fluid column thus cannot be compensated, yielding the known disadvantages mentioned in the introduction.

FIG. 3 now shows a sectional detail view of the prechamber 111 of the injector 101 from FIG. 1. Here, too, fuel is indicated by hatching. It is possible to clearly see the double-walled diaphragm 109 which seals off the piezo actuator 105 with respect to the prechamber 111 in a fluid-tight manner, such that advantageously no fluid can penetrate into the actuator housing 107. The double-walled diaphragm 109 is preferably welded, though may also be adhesively bonded, or both, to the actuator housing 107. A compressible medium 301 is arranged in the volume formed by the double wall. In the event of a pressure rise in the prechamber 111, the compressible medium 301 is compressed. In the event of a pressure drop in the prechamber 111, the compressible medium 301 expands. It is thus advantageously possible to compensate a pressure change in the prechamber 111, such that constant, consistently even pressure conditions prevail in front of the double-walled diaphragm 109. In this way, falsification of the fluid injection quantity, such as may otherwise occur in the case of multiple injections or after a relatively long standstill period when gas has accumulated in front of the diaphragm 109, can advantageously be prevented. The double-walled diaphragm 109 may thus also be referred to as a pressure compensation means.

The compressible medium 301 may be for example a gas or a foamed material, in particular a closed-pored foamed material.

FIG. 4 shows a further embodiment of the prechamber 111 in a sectional view. Here, too, fuel is indicated by hatching. Here, to seal off the piezo actuator 105, there is provided not a double-walled diaphragm similar to FIG. 3 but rather a single-walled diaphragm 401. As pressure compensation means for compensating a pressure change in the prechamber 111, there is provided a compressible ring 403 which is arranged in the prechamber 111. The compressible ring 403 comprises a compressible body 405 in which a compressible medium 407 is arranged. The body 405 seals off the compressible medium 407 with respect to the prechamber 111. The compressible medium 407 may preferably be a gas and/or a foamed material, in particular a closed-pored foamed material.

In a further embodiment which is not shown, there may be provided both a double-walled diaphragm similar to FIG. 3 for sealing off the piezo actuator 105 with respect to the prechamber 111, and also a compressible ring similar to FIG. 4. In a further embodiment which is not shown, it is also possible for a compressible cube, a compressible sphere and/or one or more compressible ring segments to be formed in addition to or instead of the compressible ring. The respective compressible medium may be the same or different in the corresponding bodies.

What is claimed is:

1. An injector, comprising:
a control valve for opening a connection between a control chamber for controlling a nozzle needle position and a prechamber of a fluid return line, and
a pressure compensation means arranged in the prechamber for compensating for a change in a prechamber pressure.

2. The injector according to claim 1, wherein the pressure compensation means has at least one body which is sealed off with respect to the prechamber and in which there is arranged a compressible medium.

3. The injector according to claim 2, wherein the compressible medium comprises a gas.

4. The injector according to claim 2, wherein the compressible medium comprises a foamed material.

5. The injector according to claim 2, wherein an actuator is provided for actuating the control valve and wherein the body is formed as a double-walled diaphragm which seals off the actuator with respect to the prechamber.

6. The injector according to claim 2, wherein the body is in the shape of a ring, ball or polygon.

7. An internal combustion engine, comprising:
at least one combustion chamber, and at least one injector arranged to inject fuel into the at least one combustion chamber, each injector comprising:
a control valve for opening a connection between a control chamber for controlling a nozzle needle position and a prechamber of a fluid return line, and
a pressure compensation means arranged in the prechamber for compensating for a change in a prechamber pressure.

8. The internal combustion engine according to claim 7, wherein the pressure compensation means has at least one body which is sealed off with respect to the prechamber and in which there is arranged a compressible medium.

9. The internal combustion engine according to claim 8, wherein the compressible medium comprises a gas.

10. The internal combustion engine according to claim 8, wherein the compressible medium comprises a foamed material.

11. The internal combustion engine according to claim 8, wherein an actuator is provided for actuating the control valve and wherein the body is formed as a double-walled diaphragm which seals off the actuator with respect to the prechamber.

12. The internal combustion engine according to claim 8, wherein the body is in the shape of a ring, ball or polygon.

13. A method for controlling an injector for an internal combustion engine, comprising:
controlling a control valve to open a connection between a control chamber for controlling a nozzle needle position and a prechamber of a fluid return line, and
compensating for a change in a prechamber pressure using a pressure compensation means arranged in the prechamber.

14. The method according to claim 13, wherein the pressure compensation means has at least one body which is sealed off with respect to the prechamber and in which there is arranged a compressible medium.

15. The method according to claim 14, wherein the compressible medium comprises a gas.

16. The method according to claim 14, wherein the compressible medium comprises a foamed material.

17. The method according to claim 14, wherein an actuator is provided for actuating the control valve and wherein the body is formed as a double-walled diaphragm which seals off the actuator with respect to the prechamber.

18. The method according to claim 14, wherein the body is in the shape of a ring, ball or polygon.
